(19) United States
(12) Patent Application Publication
(10) Pub. No.: US 2002/0152457 A1
(43) Pub. Date: Oct. 17, 2002

(54) Methods and systems for providing polymorphism in a programming language

(75) Inventor: Joerg Jahnke, Hamburg (DE)

Correspondence Address: SONNENSCHEIN NATH & ROSENTHAL, P.O. BOX 061080, WACKER DRIVE STATION, CHICAGO, IL, 60606-1080, US

(73) Assignee: Sun Microsystems, Inc.

(21) Appl. No.: 09/949,743

(22) Filed: Sep. 10, 2001

Related U.S. Application Data
(60) Provisional application No. 60/269,094, filed on Feb. 15, 2001.

(30) Foreign Application Priority Data
Sep. 8, 2000 (EP) 00119355.6

(51) Int. Cl. G06F 9/45

(52) U.S. Cl. 717/139; 717/140; 717/116

(57) ABSTRACT

Methods, systems, and articles of manufacture consistent with the present invention provide polymorphism to a language that does not inherently support polymorphism. Instructions are received from a source code file, wherein at least one of the instructions is a polymorphic extension to provide polymorphism. The source code file with the polymorphic extension is converted into executable code that performs polymorphism.

### CROSS-REFERENCE TO RELATED APPLICATIONS

The following identified U.S. and foreign patent applications are relied upon and are incorporated by reference in this application:

European Patent Application No. 00119355.6, entitled “METHOD OF PROGRAMMING FOR PROVIDING POLYMORPHISM”, filed on Sep. 8, 2000; and

U.S. Provisional Patent Application No. 60/296,094, entitled “METHOD OF PROGRAMMING FOR PROVIDING POLYMORPHISM”, filed on Jun. 5, 2001.

### FIELD OF THE INVENTION

The present invention relates to programming languages, and in particular, the invention relates to providing polymorphism in a programming language.

### BACKGROUND OF THE INVENTION

The writing of a program logic in a specific programming language (which is also referred to as coding a program or as writing the code of a program) naturally depends on the programming language itself, and more specifically, on the specific features provided by the programming language. Expressed simply, the goal of computer programming is to lay out a scheme for manipulating data stored in a data processing system in a desired way. As an example, for a database, the program logic could be a set of tools for entering or deleting data from the database, and searching and displaying data from the database.

A known programming concept, to which a number of programming languages adhere, is object-oriented programming. Object-oriented programming languages inherently support certain features that are not available in non-object-oriented programming languages and that make object-oriented programming generally more flexible than non-object-oriented programming. For example, object-oriented programming languages inherently support classes, inheritance, and polymorphism. Each of these inherent features is described below.

In object-oriented programming, a class is associated with certain attributes and certain methods, where attributes are data and methods are code (e.g., functions and routines) that act upon the data. Individual examples of a class may be generated, where each example of the class is characterized by the attributes of the class having specific values. These specific examples of a class are also referred to as instances or objects. In other words, each object belongs to a class. Methods are defined with respect to a class, and can be invoked with respect to objects of the class.

In object-oriented programming, attributes and methods are encapsulated, which means that they are presented to other objects as a unit. It is therefore possible that certain attributes cannot be directly manipulated by another object, but rather by invoking methods of the class with which the attribute is encapsulated.

Another aspect of object-oriented programming is inheritance, which relates to generating new derived classes from existing classes. Inheritance is also referred to as the deriving of classes. The class from which a new class is derived is called a superior class or super class. The new class is called a derived class. Inheritance means that the derived class will basically have the same attributes and methods as its superior class. A derived class may also contain new elements, such as new attributes and new methods. Inheritance and deriving of new classes from existing classes is, for example, provided by the “extend” statement in JAVA®, which is an object-oriented language. Sun, Sun Microsystems, the Sun logo and JAVA are trademarks or registered trademarks of Sun Microsystems, Inc. in the United States and other countries. All other company and product names may be trademarks of their respective companies.

Also, an object-oriented programming language inherently supports polymorphism. Polymorphism means that the method of a superior class may be overridden or overloaded in the derived class. Overriding means that the method of the superior class is replaced by a method having the same name, but having a different content. In other words, if a method of a specific name is invoked for a certain object, then that method in a superior class is executed for objects of derived classes in which that method was not overridden, and a different method is executed for such objects that belong to derived classes, in which that method was overridden, although the method of the same name was invoked. In other words, the same method may appear differently for different objects. This is the basis of the term “polymorphism”.

Overloading a method means that there is at least one variation of a method in a derived class, which has the same name, but has different structures of arguments, such that it may be discriminated in accordance with its arguments.

A further feature of object-oriented programming is a message, where a message is a mechanism that allows communication between individual objects. In other words, one object sends a message to another object, where the message may result in an answer containing a specific return value. Therefore, in object-oriented programming, a program will typically itself be an object that sends messages to other objects in order to obtain certain results from the other objects. In accordance with encapsulation, as described above, the way for an object to manipulate the attributes of another object is to send a message that invokes a specific method of the class to which the other object belongs. Methods of a class can also be encapsulated. In other words, these methods cannot be invoked from another object (i.e., by a message from another object), but can be invoked by other methods of the same class.

Due to the above-described features of object-oriented programming, a higher degree of flexibility is provided for generating computer programs than that provided by non-object-oriented programming. Namely, it is possible to reuse certain classes when writing a new computer program. In this respect, to make use of the flexibility of object-oriented programming, an advantageous and appropriate definition of a class hierarchy should be provided. In other words, a programmer will typically define very general classes and then derive a hierarchy of ever more specific classes in order to solve a specific problem. Each class is typically stored on the data processing system as an individual file containing the code that defines the class. Then, at least the more general classes can be reused in a new computer program, such as, by appropriately binding them into the new program with an appropriate default procedure, or by simply copying the entire code of the class into the new program. Also, abstract classes can be provided. Abstract classes are very general classes for which no objects are generated, but which serve as a basis for deriving more specific classes. An example of an abstract class is provided by the JAVA® programming language, in which the abstract class has the name “AbstractList” and the classes ArrayList and Vector are derived from this class.

An example of when object-oriented programming is useful, is when creating dynamic internet/intranet pages (e.g., network pages), where some tasks repeatedly appear. For example, in a case of a network page that requires customer input, first a customer fills out a form on the page, then the computer program checks the form (e.g., to determine whether the customer has filled in every field of the form), then the page is submitted if the form is correctly filled out, and otherwise the form is presented again to the customer so that the customer can correctly fill out the form. It is known to separate the so-called model (i.e., the actual application), the view (i.e., the way the application is presented to the user), and the controller (i.e., how the process is controlled) into separate objects, in order to reuse such code. For example, one object could be a specific view, such as, a table of data, and this specific view could be used by a plurality of different applications or programs, such that no reprogramming is necessary to reuse the view.

On the other hand, non-object-oriented programs, like procedural language programs, do not inherently support polymorphism. In procedural programming, for example, procedures and data are treated separately. Although such a concept is intuitively appealing, it provides the disadvantage that programs are inflexible, and it is difficult to change programs if new requirements are to be added or existing functions are to be changed. It also makes it difficult to reuse existing code for solving new problems. Namely, if one of the variables has to be changed (e.g., an array is amended by adding further elements), then it is necessary to check every single procedure in the program to see if the change of the variable affects any of the procedures, and if it does, then the specific procedure must be changed.

An example of a programming language that is not an object-oriented language and, therefore, does not inherently support polymorphism is the Microsoft® Visual Basic® scripting language, which will be referred to as Visual Basic® Script in the following. When creating dynamic network pages with Microsoft® Active Server® Pages, such Active Server® Pages must be prepared in accordance with Visual Basic® Script. Although version 5.0 of Visual Basic® Script has a feature of a so-called class statement and a class object, Visual Basic® Script does not inherently support polymorphism. This leads to inflexibility in connection with generating Active Server® Pages. Microsoft, Visual Basic, and Active Server are registered trademarks of Microsoft Corporation.

Based on the above-described problems of non-object-oriented programming languages, it is therefore desirable to improve them.

### SUMMARY OF THE INVENTION

Methods, systems, and articles of manufacture consistent with the present invention provide for implementing polymorphism in a non-object-oriented computer programming language, for example, in a computer programming language that does not inherently support polymorphism. This allows a computer program to override an invoked method of a superior class within a class derived from the superior class. When the method of the superior class has been overridden by an override method in the derived class, then the computer program executes the override method for the derived class instead of the method of the superior class. For example, assume Class A is a superior class having a method associated with it. Class B is a class derived from superior Class A. Accordingly, when Class B is created, it refers to a method associated with Class A. When the method of class A is invoked for an object that belongs to Class B, the computer program can override the method of Class A within Class B, such that Class B will contain an override method instead of the method of Class A. The computer program can then execute the override method for the object.

In accordance with methods consistent with the present invention, a method in a data processing system for providing polymorphism to a language that does not inherently support polymorphism is provided. The method comprises the steps of receiving instructions from a source code file, wherein at least one of the instructions is a polymorphic extension to provide polymorphism, and converting the source code file with the polymorphic extension into executable code that performs polymorphism.

In accordance with methods consistent with the present invention, a method in a data processing system is provided. The method comprises the steps of:

receiving instructions from a source code file and converting the instructions into executable code, the instructions including polymorphic extensions, a subordinate class derived from a superior class, and an object that is an instance of the subordinate class, the object contains a method, the polymorphic extensions including a method override identifier in the subordinate class, a method override determination component in the superior class, and an override method in the subordinate class; initiating execution of the executable code; and while the executable code is executing, invoking the method of the object; executing the method override determination component to determine whether the method override identifier identifies that the method overrides a corresponding method in the superior class; when it is determined that the method overrides the corresponding method of the superior class, invoking the override method; and when it is determined that the method does not override the corresponding method of the superior class, invoking the corresponding method of the superior class.

In accordance with articles of manufacture consistent with the present invention, a computer-readable medium containing instructions that cause a data processing system to perform a method for providing polymorphism to a language that does not inherently support polymorphism is provided. The method comprises the steps of receiving instructions from a source code file, wherein at least one of the instructions is a polymorphic extension to provide polymorphism; and converting the source code file with the polymorphic extension into executable code that performs polymorphism.

In accordance with articles of manufacture consistent with the present invention, a computer-readable medium containing instructions that cause a data processing system to perform a method is provided. The method comprises the steps of: receiving instructions from a source code file and converting the instructions into executable code, the instructions including polymorphic extensions, a subordinate class derived from a superior class, and an object that is an instance of the subordinate class, the object contains a method, the polymorphic extensions including a method override identifier in the subordinate class, a method override determination component in the superior class, and an override method in the subordinate class; initiating execution of the executable code; and while the executable code is executing, invoking the method of the object; executing the method override determination component to determine whether the method override identifier identifies that the method overrides a corresponding method in the superior class; when it is determined that the method overrides the corresponding method of the superior class, invoking the override method; and when it is determined that the method does not override the corresponding method of the superior class, invoking the corresponding method of the superior class.

In accordance with systems consistent with the present invention, a data processing system is provided. The data processing system comprises a secondary storage device comprising a source code file written in a language that does not inherently support polymorphism; a memory comprising a computer program that receives instructions from the source code file, wherein at least one of the instructions is a polymorphic extension to provide polymorphism, and converts the source code file with the polymorphic extension into an executable code that performs polymorphism; and a processing unit that runs the computer program.

In accordance with systems consistent with the present invention, a data processing system for providing polymorphism to a language that does not inherently support polymorphism is provided. The data processing system comprises means for receiving instructions from a source code file, wherein at least one of the instructions is a polymorphic extension to provide polymorphism, and means for converting the source code file with the polymorphic extension into executable code that performs polymorphism.

In accordance with articles of manufacture consistent with the present invention, a computer-readable memory device encoded with a data structure with entries is provided. Each entry is associated with a derived class that is derived from a superior class, wherein the derived class is accessed by a host program which is encoded on the memory device and which is run by a processor in a system, the derived class having an overriding method and the superior class having an overridden method. Each entry comprises an identifier of an overridden method such that the host program examines the entry to determine whether to perform polymorphism.

The above-mentioned and other features, utilities, and advantages of the invention will become apparent from the following detailed description of the preferred embodiments of the invention together with the accompanying drawings.

Other systems, methods, features, and advantages of the invention will become apparent to one with skill in the art upon examination of the following figures and detailed description. It is intended that all such additional systems, methods, features, and advantages be included within this description, be within the scope of the invention, and be protected by the accompanying drawings.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention. In the drawings,

FIG. 1 depicts a block diagram of a data processing system with which embodiments of the present invention may be implemented;

FIG. 2 depicts a block diagram of a class defining code piece of a derived class and a class defining code piece of its superior class, in accordance with methods, system, and articles of manufacture consistent with the present invention;

FIG. 3 depicts a block diagram of a data structure with which embodiments of the present invention may be implemented;

FIG. 4 depicts a block diagram of a client-server based data processing system with which embodiments of the present invention may be implemented;

FIG. 5 depicts a flow diagram illustrating the steps of providing polymorphism in a computer programming language, in accordance with methods, systems, and articles of manufacture consistent with the present invention;

FIG. 6 depicts a block diagram of a class defining code piece of a derived class and a class defining code piece of its superior class, in accordance with methods, system, and articles of manufacture consistent with the present invention; and

FIG. 7 depicts a flow diagram illustrating the steps of a method override determination procedure, in accordance with methods, systems, and articles of manufacture consistent with the present invention.

### DETAILED DESCRIPTION OF THE INVENTION

Reference will now be made in detail to an implementation consistent with the present invention as illustrated in the accompanying drawings. Wherever possible, the same reference numbers will be used throughout the drawings and the following description to refer to the same or like parts.

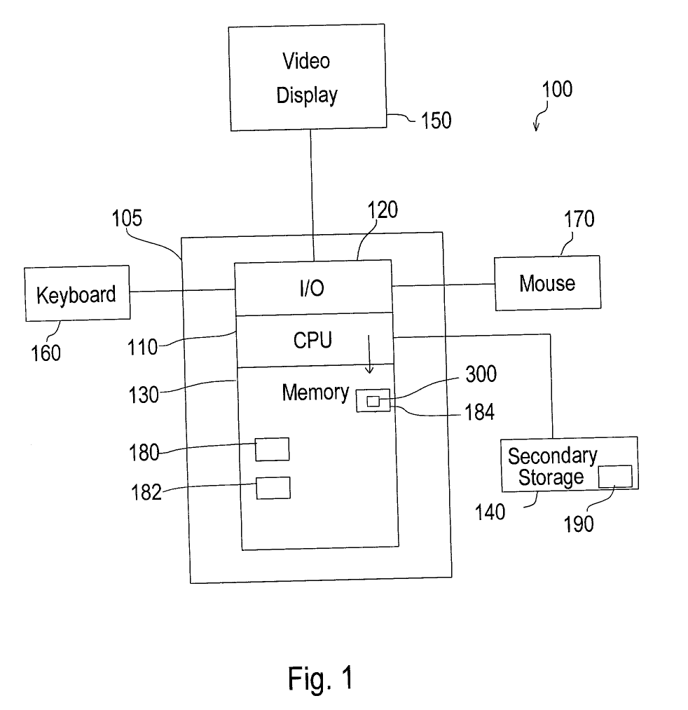

FIG. 1 depicts a block diagram of a data processing system 100 suitable for practicing methods and implementing systems consistent with the present invention. The data processing system 100 comprises a central processing unit (CPU) 110, an input output I/O unit 120, a memory 130, a secondary storage device 140, and a video display 150. The data processing system 100 may further comprise standard input devices such as a keyboard 160, a mouse 170 or a speech processing means (not illustrated).

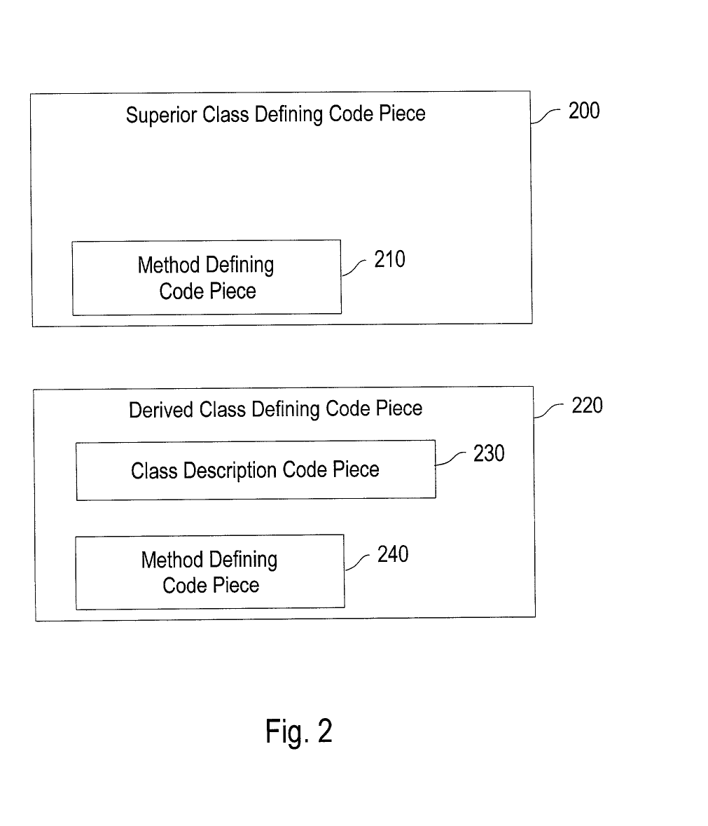

The memory 130 contains a source code file 180 comprising source code, an interpreter program 182, and an executable program 184 based on an executable code file. An example of portions of source code are schematically depicted in FIG. 2. The exemplary portions of source code include a superior class defining code piece 200 having a method defining code piece 210, and a derived class defining code piece 220 having a method defining code piece 230. The term code piece refers to one or more lines of program code. The exemplary portions of source code will be described below. The interpreter 182 also converts individual lines of source code 180 into executable code of an executable program 184 for running on the data processing system 100. As can be appreciated by one of skill in the art, the data processing system 100 can comprise a compiler, which can convert the source code into executable code. Interpreters and compilers and their functions are known to those of skill in the art. Accordingly, further description of the interpreter 182 and compilers will not be further described herein. Data affected by a running of the executable program 184 is viewed on the video display 150.

FIG. 2 depicts portions of source code that are received by the interpreter from, for example, a computer programmer and stored on the data processing system. Reference numeral 200 refers to a class defining code piece that contains information that defines a superior class. The superior class is a class from which further classes may be derived. The specific information that is contained in the superior class defining code piece 200, as well as other code pieces described herein, depends on the specific programming language used to write the superior class defining code piece 200.

Reference numeral 210 refers to a method defining code piece contained in the superior class defining code piece 200. The method defining code piece 210 comprises lines of program code that contain information for defining a method that belongs to the superior class defining code piece 200.

Reference numeral 220 refers to a class defining code piece that contains information that defines a class derived from the superior class, which is defined in the superior class defining code piece 200. The derived class defining code piece 220 contains a class description code piece 230. The class description code piece 230 is a piece of program code that contains information describing the derived class defined in the derived class defining code piece 220. Reference numeral 240 refers to a method defining code piece contained in the derived class defining code piece 220. The method defining code piece 240 comprises lines of program code that contain information for defining a method that belongs to the derived class defining code piece 200. When the derived class is first created, the method defining code piece 240 contains program code that is similar to that which defines the method in the method defining code piece 210 of the superior class.

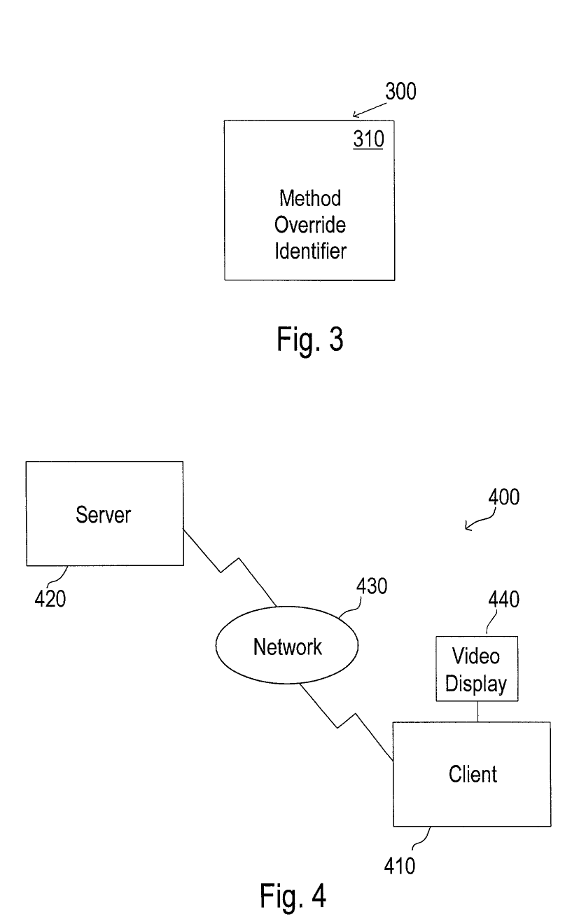

Referring back to FIG. 1, the executable program 184 includes a data structure 300 having entries reflecting each class description code piece of each derived class. FIG. 3 depicts a more detailed diagram of the data structure 300. The sample data structure 300 that is depicted in FIG. 3 illustrates a class description code piece for, for example, a single derived class. The data structure 300 has an entry for a method override identifier 310. The method override identifier 310 of the class description code piece identifies a superior class method to be overridden in the derived class. For example, a method override identifier, which is contained in a class description code piece of a derived class A, contains a method override identifier of a method of superior class B, where derived class A has been derived from superior class B.

Although aspects of one implementation are depicted as being stored in memory, one skilled in the art will appreciate that all or part of systems and methods consistent with the present invention may be stored on or read from other computer-readable media, such as secondary storage devices, like hard disks, floppy disks, and CD-ROM; a carrier wave received from a network such as the Internet; or other forms of ROM or RAM. Further, although specific components of data processing system 100 have been described, one skilled in the art will appreciate that a data processing system suitable for use with methods, systems, and articles of manufacture consistent with the present invention may contain additional or different components.

One skilled in the art will appreciate that methods, systems, and articles of manufacture consistent with the present invention may also be implemented in a client-server environment, like the one depicted in FIG. 4. FIG. 4 depicts a block diagram of a client-server based data processing system 400 with which methods, systems, and articles of manufacture consistent with the present invention may be implemented. A client computer system 410 and a server computer system 420 are each connected to a network 430, such as a Local Area Network, Wide Area Network, or the Internet. A derived class defining code piece can be stored on the client computer system 410 while some or all steps of the processing as described below can be carried out on the server computer system 420, which is accessed by the client computer system 410 over the network 430.

In a typical program that is written in a language that does not inherently support polymorphism, a method that is defined in a superior class cannot be overridden in a class derived from the superior class through polymorphism. In accordance with methods, systems, and articles of manufacture consistent with the present invention, if a method in a superior class is to have the capability of being overridden in a class derived from the superior class, then a method override determination procedure is associated with the method in the superior class. Then when the executable program is run, the method override determination procedure is performed when the method is to be overridden in the derived class. Referring to the example of FIG. 2, if a method in the superior class, which is defined by the superior class defining code piece 200, is to be overridden, then a method override determination procedure is associated with the method. The method override determination procedure is described in more detail below. Further, if the method defined in the superior class is to be overridden in a class derived from the superior class, then a method override identifier is associated with the derived class, and an override method (i.e., a method that overrides the method of the superior class in the derived class) is associated with the derived class. Referring to the example of FIG. 2, if the method defining code piece 240 of the derived class contains the method defined in the superior class, then in order to override the method in the derived class, a method override identifier and an override method are associated with the derived class. The method override identifier and the override method will also be described in more detail below.

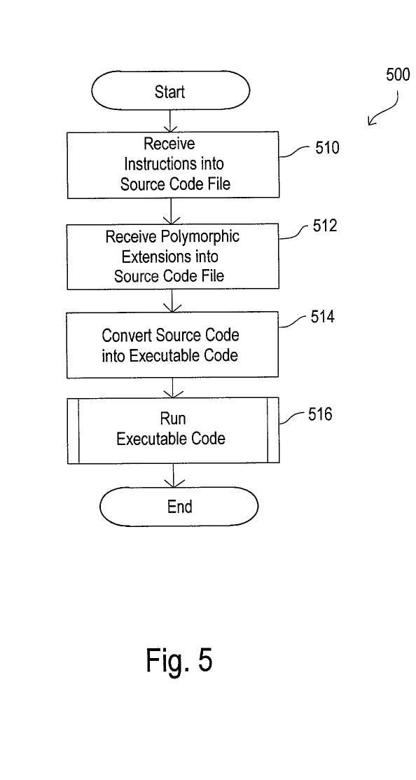

FIG. 5 depicts a flow diagram 500 illustrating exemplary steps for providing polymorphism in a computer program that does not inherently, via its language, already have it as a feature of its language. In accordance with methods, systems, and articles of manufacture consistent with the present invention, a superior class method that is defined in a source code file is modified such that it may be overridden, and an override method for overriding the superior class method is implemented in a class derived from the superior class. First, the interpreter receives instructions from, for example, a computer programmer into the source code file (steps 510). In addition to other possible elements, the received instructions comprise instructions that define the superior class, the superior class method, the derived class that is derived from the superior class, the class description code piece of the derived class, and the derived class method. For example, referring to the example depicted in FIG. 2, the interpreter receives instructions comprising the superior class defining code piece 200 to define the superior class, the method defining code piece 210, the derived class defining code piece 220 that defines the derived class, the class description code piece 230, and the method defining code piece 240.

The instructions that the interpreter receives in step 510, do not attempt to invoke a polymorphism facility in the language, as provided by the interpreter, because the computer program is written in the language that does not inherently support polymorphism.

Then, the interpreter receives polymorphic extensions into the source code file from the computer programmer (step 512). A polymorphic extension is a source code piece that provides the feature of polymorphism to the existing source code, which is written in a language that does not inherently support the feature of polymorphism.

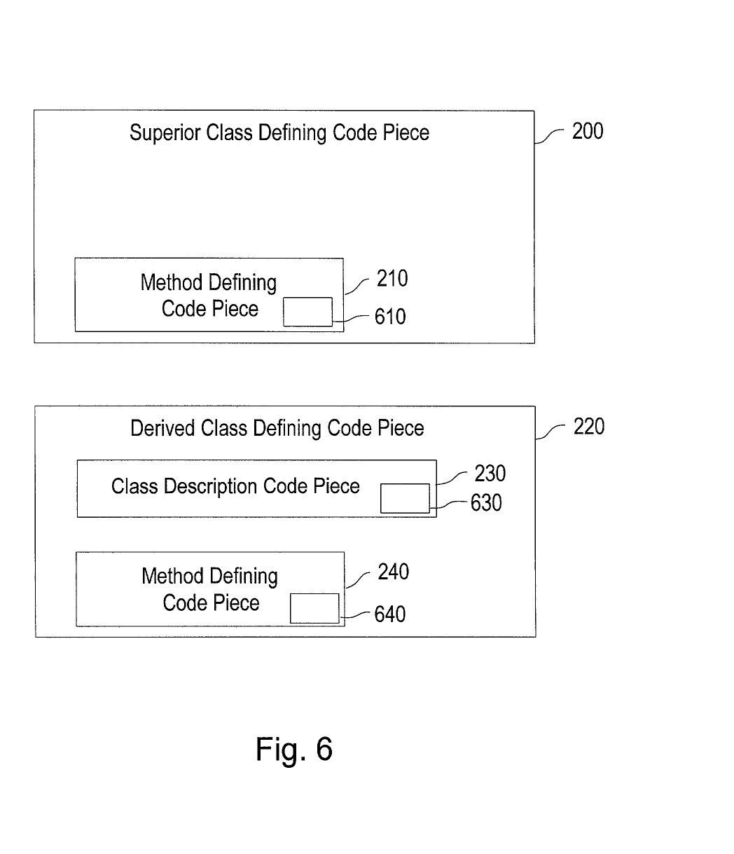

The polymorphic extensions that are received into the source code comprise a method override determination procedure, a method override identifier, and an override method. The interpreter receives code comprising the method override determination procedure into the method defining code piece of the superior class. Thus, the method override determination procedure is associated with the superior class method, such that the superior class method may be overridden in a derived class. FIG. 6 depicts the portions of source code illustrated in FIG. 2 after the polymorphic extensions have been inserted into the source code by the interpreter in step 512. For example, FIG. 6 schematically illustrates the method override determination procedure 610 inserted into the method defining code piece 210 of the superior class.

Referring back to FIG. 5, in step 512, the interpreter can also receive code comprising a method override identifier into the class description code piece of the derived class. The method override identifier is inserted into the source code of the derived class of which it is intended to override the superior class method. FIG. 6 schematically illustrates the method override identifier 630 inserted into the class description code piece 230 of the derived class.

In step 512, the interpreter can also receive code comprising an override method into the method defining code piece of the derived class. The override method is the method that is intended to override the superior class method within the derived class. FIG. 6 schematically illustrates the override method 640 inserted into the method defining code piece 240 of the derived class.

One of skill in the art will appreciate that step 512 can be integrated into step 510.

Once the interpreter has received the polymorphic extensions into the source code file, then the interpreter converts the source code file into an executable code file (step 514). Converting source code into executable code using an interpreter is well known to one of skill in that art and need not be explained in detail here. Converting source code written in a language that does not inherently support polymorphism into executable code is described, for example, in R. Kaplan, Constructing Language Processors for Little Languages, J. Wiley and Sons, 1994, ISBN 0471597546, which is incorporated herein by reference.

Once the source code has been converted into executable code in step 514, the executable program that is defined by the executable code can be run on the data processing system, including providing the feature of polymorphism (step 516).

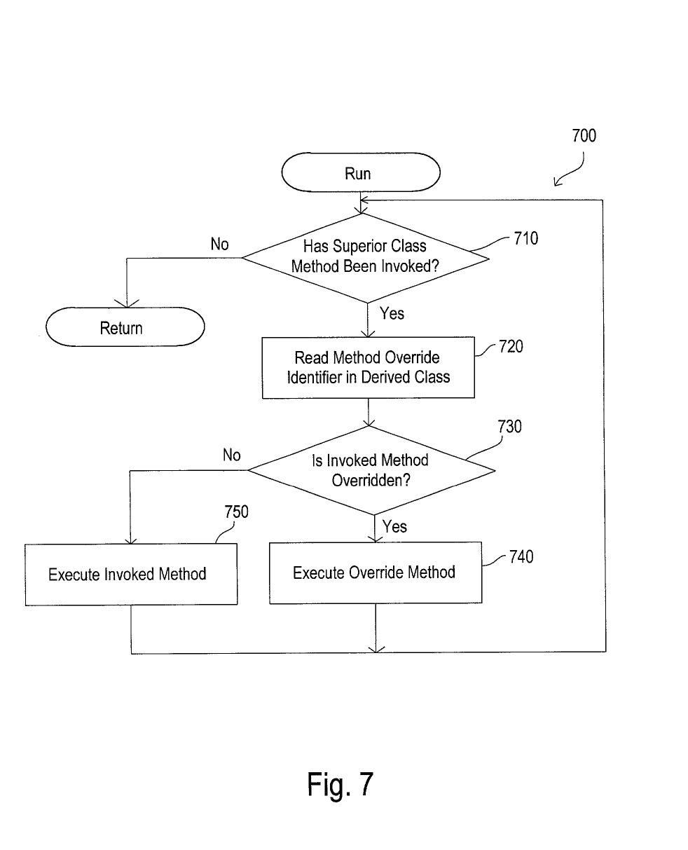

FIG. 7 depicts a flow diagram illustrating, in more detail, a method of the steps performed by the executable program when the executable program invokes a method defining code piece of a superior class. The executable program first determines whether the method defined in the method defining code piece of a superior class has been invoked (step 710). The invocation can be, for example, a call function, and can indicate an object for which the method is invoked. In that case, the object is an argument that is passed with the method call. The derived class is the class of the object for which the method is invoked.

If the executable program determines that such a method was invoked in step 710, then the executable program executes the method override determination procedure that is associated with the method defining code piece of the superior class. Referring to the example depicted in FIG. 6, the executable program executes the method override determination procedure 212 associated with the method defining code piece 210 of the superior class. Referring back to FIG. 7, the steps of the method override determination procedure are depicted as steps 720, 730, 740 and 750.

According to the method override determination procedure, the executable program first reads the method override identifier in the derived class, which is the class of the object for which the method was invoked (step 720). The method override identifier can be the name of the overridden method, such as the name of the method defined in the method defining code piece of the superior class. Although this can be done for simplicity, it is possible to implement other identification schemes using any type of suitable indicator. Referring to the example depicted in FIG. 6, the executable program reads the method override identifier 232 in the class description code piece 230 of the derived class. FIG. 6 shows one method override identifier 232, but it is possible that the class description code piece 230 contains no method override identifier 232, which signifies that no method is overridden in the class defined by derived class defining code piece 220, or several method override identifiers, which signifies that several methods are overridden, where the several overridden methods may belong to a single superior class, or to multiple superior classes.

Referring back to FIG. 7, the executable program then determines, based on the method override identifier read from the derived class in step 720, whether the invoked method in the derived class has been overridden (step 730). The executable program will determine that the method has been overridden when the method override identifier identifies the method defining code piece of the superior class. Referring to the example depicted in FIG. 6, the executable program will determine that the method of the derived class has been overridden when the method override identifier 232 of the derived class indicates the name of the method in the method defining code piece 210 of the superior class.

Referring back to FIG. 7, if the executable program determines that the invoked method in the derived class has been overridden in step 730, then the executable program executes the override method defined in the method defining code piece of the derived class (step 740). The executable program can call the override method, for example, on the basis of a name corresponding to the override method. For simplicity, the name of the override method in the derived class can be based on the name of the method of the superior class to be overridden, by combining the name of the method to be overridden with a predetermined default string. For example, the override method name can be derived by adding the above-mentioned string to the name of the method defined in the method defining code piece of the superior class.

If the executable program determines that the invoked method in the derived class has not been overridden in step 730, then the executable program executes the method defined in the method defining code piece of the superior class (step 750).

After the executable program executes the method in step 740 or step 750, then the executable program returns to step 710 determine whether another superior class method has been invoked.

In this manner, when the method defined in method defining code piece of superior class is invoked, either the method actually defined in the method defining code piece of the superior class is executed, or the override method defined in the method defining code piece of the derived class is executed, depending on the method override identifier in the class description code piece of the derived class. In other words, invoking the method defined in method defining code piece of the superior class can lead to the execution of different procedures for different objects, which means that polymorphism is provided.

One of skill in the art will appreciate that the code pieces depicted in FIG. 6 and the flow diagrams 500 and 700 depicted in FIGS. 5 and 7, respectively, are examples and are not restrictive. The method steps, for example, may be arranged in a different order. Also, more than one superior class method may be overridden. Further, it is possible that the interpreter will receive instructions that define a superior class and that enable one or more of its methods to be overridden, and then methods will not be overridden when the executable code is run. Since these superior class methods carry the option of being overridden by an appropriately inserted an override identifier, the program thus has the feature of polymorphism, which may, for example, be employed when reusing the superior class in the context of a new program, in which it might then be desirable to override one or more of its methods.

Further, the code pieces that define the polymorphic extensions do not have to be embedded directly in their associated class defining code pieces. The interpreter can insert, for example, procedural calls that call the code pieces, which define the polymorphic extensions, into the class defining code pieces. Also, if a method has been overridden, then the executable program can add a supplementary identifier which identifies the override method to the method override identifier. Accordingly, when the executable program determines that the method has been overridden in step 730, it will then identify which override method to execute in step 750 based on the supplementary identifier.

Now detailed code examples will be described for an implementation in accordance with methods, systems, and articles of manufacture consistent with the present invention.

The following code examples are based on Visual Basic® Script, which is a non-object-oriented programming language to which embodiments consistent with the present invention can be applied. Also, for a better understanding, comparative code examples in JAVA® will sometimes be given. Moreover, the examples described in the following will be given in the context of Active Server® Pages.

Details regarding the various commands, default elements and general structure of Visual Basic® Script can be found in any appropriate technical digest, such as, “VBScript Programmer's Reference” by Adrian Kingsley-Hughes et al., 1st edition October 1999, Wrox Press Inc., ISBN 1861002718, which is incorporated herein by reference. Therefore, a complete repetition of the various elements of Visual Basic® Script is not necessary here. Also, details of Active Server® Pages may be found in any appropriate reference digest, such as, “Professional Active Server Pages 3.0” by Alex Homer et al., 3rd edition, September 1999, Wrox Press Inc., ISBN 1861002610, which is incorporated herein by reference.

Further, the following description will make reference to a set of appended code examples referred to as Class.inc, Object.inc, ShowTableView.inc, and ShowTablePageView.inc. The code examples are merely illustrative and do not limit the present disclosure to the precise form disclosed.

Class Defining Code Piece Examples:

In accordance with embodiments consistent with the present invention, as described above, two functional entities (i.e., classes) are defined. Namely, a base class for objects from which other objects are derived is defined. This base class has the name “object” and is included in the appended code examples as Object.inc. Further, a class which describes objects of a given class is defined. This class has the name “class” and is included in the appended code examples as Class.inc. These classes are defined, for example, in step 510 of FIG. 5, where the interpreter receives instructions into the source code file.

An object stores two types of information, namely the name of the class it belongs to and its data (e.g., the values of its one or more attributes). The class name can be represented as a one-dimensional array, and the object data as a dictionary object (as provided by Visual Basic® Script) that maps class-attribute names to their respective values.

The class information that defines the class consists of the name of the class, the names of the methods of superior classes which are overridden in this class (e.g., method override identifier), and the class description of its superior class. With this information, an object can encapsulate data (e.g., in its dictionary object) and inherit data from superior classes (namely the superior classes' entries in the same dictionary).

In a source code, a class defining code piece of a new class appears as a set of functions with every function having the class name as a prefix, and every method (except for constructors and static methods) of the class having a class-instance as a first parameter. To give an example, the JAVA® class

public class Test
{
public Test() {}
public void methodA() {}
}

in accordance with an embodiment consistent with the present invention has the following illustrative source code:

//class description

Dim TEST_CLASSDESCRIPTION

TEST_CLASSDESCRIPTION=Array(“Test”, Array( ),

OBJECT_CLASSDESCRIPTION)

//the constructor needs a class description function Test_create(aClassDescription)

Test_create=Class_newInstance(aClassDescription) end function

//the method “methodA” needs the object of class “Test” sub Test_methodA(aTestObject)

.

.

.

end sub

As illustrated, this example of a class defining code piece first contains a class description code piece. The statement “Dim” is simply a declaration. Then the declared variable TEST_CLASSDESCRIPTION is assigned an array having three elements: the name “Test”, which is the name of the class being described; an array that is empty in the above example; and the string OBJECT_CLASSDESCRIPTION, which identifies the superior class from which the class “Test” is derived, namely the class “Object” (see Object.inc in the appended code examples).

Then, a constructor is defined. As is well known in the field of object-oriented programming, a constructor is a method in a class that generates an object of that class. In the above example, the constructor is provided by a function Class_newInstance, where aClassDescription is the argument. The function Class_newInstance is defined in the class Class.inc (see appended code examples). The Visual Basic® Script keywords “function” and “end function” respectively indicate the start and end of the function code. In accordance with the well known convention from object-oriented programming, the keyword “new” is included in the name of the constructor function Class_newInstance in order to illustrate that it is new. As can be seen in the appended coded samples, this function Class_newInstance creates an array having the descriptor handed over as the argument (aClassDescriptor) together with a dictionary object created in accordance with the known specifications of Visual Basic® Script.

Then, the above-shown example of a class defining code piece shows the frame of a method defining code piece, which in the above example is a sub routine (as defined by the Visual Basic® Script statement “sub”). The vertical dots between the “sub” statement and the “end sub” statement indicate any arbitrary method that is appropriately defined. In the above-shown example, the method has the name Test_methodA and has an object as an argument.

A class that is created in this way can be used in an executable program via server-side include-commands. An example of such a server-side include-command in Active Server® Pages is <!—## include virtual=“/classes/test.inc”—>, where this example presumes that the illustrative class defining code piece was saved in the file “test.inc”. In this way the code of the class “Test” is copied into an Active Server® Page currently being processed by the executable program. It is also possible to copy the class defining code piece and paste it into an Active Server® Page.

Polymorphic Extensions Code Piece Examples:

In accordance with embodiments consistent with the present invention, the function of polymorphism is provided through the insertion of polymorphic extensions into the source code. The illustrative polymorphic extensions that are described below can be inserted into the source code, for example, during step 512 of FIG. 5.

As an example, a class having the name “Test2” is derived from the superior class “Test”. In JAVA® this looks like:

Public class Test1 extends Test
{
public Test2(){super(); }
public void methodA() {}
public void methodB() {}
}

In accordance with embodiments consistent with the present invention, the Visual Basic Script® source code looks like:

Dim TEST2_CLASSDESCRIPTION

TEST2 CLASS_DESCRIPTION=Array(“Test2”,Array(“Test methodA”),

TEST_CLASSDESCRIPTION)

Function Test2_create(aClassDescription) Test2_create=Class_newInstance(aClassDescription) end function

sub Test_customMethodA(aTestObject)

.

.

.

end sub

sub Test2_methodB(aTestObject)

.

.

.

end sub

In the above-described JAVA® example and the above-described Visual Basic® Script example, the executable program overrides methodA in class “test2” with a new methodB that was not defined in the superior class.

In the above-described Visual Basic® Script example, there is again a section of the class defining code piece that first provides a “Dim” statement for declaring variable TEST2_CLASSDESCRIPTION, which is assigned an array having three elements: the name of the class (“Test2”); an array; and a string TEST_CLASSDESCRIPTION. As previously indicated, TEST_CLASSDESCRIPTION identifies that the superior class from which Test2 is derived is the class “Test”. The string “Test_methodA” contained in the array is a method override identifier that indicates that Test_methodA is overridden in the class “Test2”. The array can contain a plurality of such method override identifiers, such as, several names of methods of superior classes that are overridden in “Test2”. Since the corresponding array in the class description code piece for the previously described class “Test” is empty, no methods of classes superior to the class “Test” are overridden in the class “Test”.

Then, as can be seen from the above-described example of the class defining code piece related to class “Test2”, the constructor is defined in the same way as the constructor was defined in the class defining code piece relating to the class “Test” above. Accordingly, a further description of the constructor is not presented herein.

Then, in the above-described example, the method for overriding Test_methodA is a sub routine having the name Test_customMethodA. In other words, the sub routine has a name that is derived by combining the name of the method being overridden with a default string. In the illustrative example, the default string is “custom”. On the other hand, as can also be seen, the additional method (method B in the JAVA® example) is defined as Test2_methodB, which is similar to the definition of Test_methodA in the class defining code piece related to the class “Test”.

In order to implement an example of a method override determination procedure, the following code piece is received into the method defining code piece of Test_methodA:

sub Test_methodA( aTestObject )

```
// if this method is overloaded in the class of a TestObject
  if Class_isMethodOverloaded( Object_getClass( aTestObject ),
  “Test_methodA” ) then
```

// call “methodA” in the derived class
call Test_customMethodA( aTestObject )

else
// implementation of “methodA” for class “Test”
.
.
.
end if
end sub

More specifically, this sub routine definition replaces the definition shown above for Test_methodA. As can be seen, there is an additional call for a function Class_isMethodOverloaded, where the function is once again defined in the appended code example, namely in Class.inc. This function Class_is Method Overloaded returns the value “true” if the method is overloaded (if the method is named in the corresponding array), otherwise the function returns the value “false”. Then, if Test_methodA is overridden (as shown in the above example), then Test_customMethodA is called, namely the override method defined in the class defining code piece that defines the class “Test2”. Otherwise, the implementation of Test_methodA is executed, which is defined in the method defining code piece of class “Test”.

In this example, the naming of override methods in derived classes follows a convention of providing the name of the superior class, followed by an underscore, and followed by the string “custom” and the name of the overridden method. One of skill in the art will appreciate that the string “custom” could be replaced by any other arbitrary string and that this additional string could be combined with the overridden method name in any desired way. The name of the superior class is used in the name, because the superior class does not know about the derived classes it will have in the future.

The above-described examples can be applied, for example, to the creation of models, views and controllers for Web-based applications. The appended code examples give two specific examples, namely the files ShowTableView.inc and ShowTablePageView.inc. In this respect, the class ShowTableView.inc is used to display a database table at an HTML-table. The appended code examples also show how the class would be used in an Active Server® Page. The class ShowTablePageView.inc is a view that also displays a table, but segments the table into several pages that the user can leaf through. It is included to show how a derived class is implemented.

The foregoing description of an implementation of the invention has been presented for purposes of illustration and description. It is not exhaustive and does not limit the invention to the precise form disclosed. Modifications and variations are possible in light of the above teachings or may be acquired from practicing of the invention. For example, the described implementation includes software but the present implementation may be implemented as a combination of hardware and software or hardware alone. The invention may be implemented with both object-oriented and non-object-oriented programming systems. The scope of the invention is defined by the claims and their equivalents.

[image]

[image]

[image]

[image]

[image]

[image]

[image]

[image]

[image]

[image]

[image]

[image]

[image]

[image]

What is claimed is:

1. A method in a data processing system for providing polymorphism to a language that does not inherently support polymorphism, the method comprising the steps of:
receiving instructions from a source code file, wherein at least one of the instructions is a polymorphic extension to provide polymorphism; and
converting the source code file with the polymorphic extension into executable code that performs polymorphism.

2. The method of claim 1, wherein the step of converting further comprises interpreting the source code file with the polymorphic extensions into executable code that performs polymorphism.

3. The method of claim 1, wherein the step of converting further comprises compiling the source code file with the polymorphic extensions into executable code that performs polymorphism.

4. The method of claim 1, wherein the source code file includes:
a method override identifier in a subordinate class derived from a superior class;
a method override determination component in the superior class; and
a override method in the derived class.

5. The method of claim 4, wherein the method override identifier is a string comprising the name of an overridden method.

6. The method of claim 4, wherein the derived class includes a class description code piece, and wherein the method override identifier is in the class description code piece.

7. The method of claim 6, wherein the class description code piece comprises a declaration of a class description array, the method override identifier being an element of the array.

8. The method of claim 7, wherein the class description array comprises a name of the derived class, and a name of the superior class.

9. The method of claim 1, further comprising the step of:
running the executable code such that polymorphism is performed.

10. The method of claim 9, wherein running the executable code further comprises:
executing a method override determination component associated with a method of a superior class to determine whether a method override identifier associated with a derived class that is derived from the superior class identifies that a method of the superior class is to be overridden in the derived class; and
when it is determined that the method of the superior class is to be overridden, overriding the method of the superior class with an override method associated with the derived class.

11. The method of claim 10, wherein the step of running the executable code further comprises:
invoking the method of the superior class for an object;
when it is determined that the method of the superior class is to be overridden, executing the override method for the object; and
when it is determined that the method of the superior class is not to be overridden, executing the method of the superior class for the object.

12. A method in a data processing system, the method comprising the steps of:
receiving instructions from a source code file and converting the instructions into executable code, the instructions including polymorphic extensions, a subordinate class derived from a superior class, and an object that is an instance of the subordinate class, the object contains a method, the polymorphic extensions including a method override identifier in the subordinate class, a method override determination component in the superior class, and an override method in the subordinate class;
initiating execution of the executable code; and
while the executable code is executing,
invoking the method of the object;
executing the method override determination component to determine whether the method override identifier identifies that the method overrides a corresponding method in the superior class;
when it is determined that the method overrides the corresponding method of the superior class, invoking the override method; and
when it is determined that the method does not override the corresponding method of the superior class, invoking the corresponding method of the superior class.

13. A computer-readable medium containing instructions that cause a data processing system to perform a method for providing polymorphism to a language that does not inherently support polymorphism, the method comprising the steps of:
receiving instructions from a source code file, wherein at least one of the instructions is a polymorphic extension to provide polymorphism; and
converting the source code file with the polymorphic extension into executable code that performs polymorphism.

14. The computer-readable medium of claim 13, wherein the step of converting further comprises interpreting the source code file with the polymorphic extensions into executable code that performs polymorphism.

15. The computer-readable medium of claim 13, wherein the step of converting further comprises compiling the source code file with the polymorphic extensions into executable code that performs polymorphism.

16. The computer-readable medium of claim 13, wherein the source code file includes:
a method override identifier in a derived class that is derived from a superior class;
a method override determination component in the superior class; and
a override method in the derived class.

17. The computer-readable medium of claim 16, wherein the method override identifier is a string comprising the name of an overridden method.

18. The computer-readable medium of claim 16, wherein the first class defining code piece includes a class description code piece, and wherein the method override identifier is in the class description code piece.

19. The computer-readable medium of claim 18, wherein the class description code piece comprises a declaration of a class description array, the method override identifier being an element of the array.

20. The computer-readable medium of claim 19, wherein the class description array comprises a name of the derived class, and a name of the superior class.

21. The computer-readable medium of claim 13, further comprising the step of:
running the executable code such that polymorphism is performed.

22. The computer-readable medium of claim 21, wherein running the executable code further comprises:
executing a method override determination procedure associated with a method of a superior class to determine whether a method override identifier associated with a derived class that is derived from the superior class identifies that a method of the superior class is to be overridden in the derived class; and
when it is determined that the method of the superior class is to be overridden, overriding the method of the superior class with an override method associated with the derived class.

23. The computer-readable medium of claim 22, wherein the step of running the executable code further comprises:
invoking the method of the superior class for an object;
when it is determined that the method of the superior class is to be overridden, executing the override method for the object; and
when it is determined that the method of the superior class is not to be overridden, executing the method of the superior class for the object.

24. A computer-readable medium containing instructions that cause a data processing system to perform a method comprising the steps of:
receiving instructions from a source code file and converting the instructions into executable code, the instructions including polymorphic extensions, a subordinate class derived from a superior class, and an object that is an instance of the subordinate class, the object contains a method, the polymorphic extensions including a method override identifier in the subordinate class, a method override determination component in the superior class, and an override method in the subordinate class;
initiating execution of the executable code; and
while the executable code is executing,
invoking the method of the object;
executing the method override determination component to determine whether the method override identifier identifies that the method overrides a corresponding method in the superior class;
when it is determined that the method overrides the corresponding method of the superior class, invoking the override method; and
when it is determined that the method does not override the corresponding method of the superior class, invoking the corresponding method of the superior class.

25. A data processing system comprising:
a secondary storage device comprising a source code file written in a language that does not inherently support polymorphism;
a memory comprising a computer program that receives instructions from the source code file, wherein at least one of the instructions is a polymorphic extension to provide polymorphism, and converts the source code file with the polymorphic extension into an executable code that performs polymorphism; and
a processing unit that runs the computer program.

26. The data processing system of claim 21, wherein the computer program runs the executable code such that polymorphism is performed.

27. A data processing system for providing polymorphism to a language that does not inherently support polymorphism, the data processing system comprising:
means for receiving instructions from a source code file, wherein at least one of the instructions is a polymorphic extension to provide polymorphism; and
means for converting the source code file with the polymorphic extension into executable code that performs polymorphism.

28. The data processing system of claim 27, further comprising:
means for running the executable code such that polymorphism is performed.

29. A computer-readable memory device encoded with a data structure with entries, each entry is associated with a derived class that is derived from a superior class, wherein the derived class is accessed by a host program which is encoded on the memory device and which is run by a processor in a system, the derived class having an overriding method and the superior class having an overridden method, each entry comprising:
an identifier of an overridden method such that the host program examines the entry to determine whether to perform polymorphism.
